(19) United States
(12) Patent Application Publication
(10) Pub. No.: US 2022/0299054 A1
(43) Pub. Date: Sep. 22, 2022

(54) CONNECTOR WITH ONE OR MORE WINDOWS FOR VIEWING RESISTANCE SPOT WELD

(71) Applicant: Norma U.S. Holding LLC, Auburn Hills, MI (US)

(72) Inventors: Miguel Angel Gallegos de la Peña, Cd. Juarez (MX); David Reyes Lopez, Cd. Juarez (MX)

(21) Appl. No.: 17/700,688

(22) Filed: Mar. 22, 2022

Related U.S. Application Data
(60) Provisional application No. 63/164,065, filed on Mar. 22, 2021.

(51) Int. Cl. F16B 5/08

(52) U.S. Cl. CPC F16B 5/08; F16L 21/065

(57) ABSTRACT

A connector used to join metal pipes, rubber hoses, and other tubular bodies and lines together in order to establish a fluid-tight joint therebetween. The connector is a v-clamp in an example. One or more windows reside in a metal wall portion of the connector. The metal wall portion is a part of a band of the connector, per an example. The window(s) is located at a resistance spot welding site. By way of the window(s), an inspector can visually view and examine whether an intended resistance spot weld has been properly established at the metal wall portion of the connector.

### CROSS-REFERENCE TO RELATED APPLICATION

This application claims the benefit of U.S. Provisional Patent Application No. 63/164,065, with a filing date of Mar. 22, 2021, the contents of which are hereby incorporated by reference in their entirety.

### TECHNICAL FIELD

This disclosure relates generally to bands composed of metal that are employed in use with connectors of various sorts for joining pipes and hoses and other tubular bodies and lines together, and relates to resistance spot welds in the bands for attachment of abutting walls and ways to verify whether a proper resistance spot weld has been established.

### BACKGROUND

Connectors are used to join pipes and hoses and other tubular bodies and lines together in a fluid-tight manner. Connectors are employed in automotive applications, as well as aerospace, marine, machine, and agricultural applications, among others. One example of a connector is a pipe clamp that joins automotive exhaust pipes together. Another example is a hose clamp. Bands of sheet metal, usually stainless steel, typically constitute main structures of connectors and extend circumferentially around the tubular bodies being joined. Resistance spot welds can be prepared between abutting metal walls of the connectors—and oftentimes at the bands—in order to form an attachment thereat. In general, resistance spot welding is a process that involves two opposing welding electrodes pressed toward each other and sandwiching abutting metal workpieces. Current is passed across the welding electrodes and through the workpieces, and resistance to current flow causes the affected metal to melt at an interface between the workpieces. A weld nugget is formed therebetween, and upon solidification attaches the workpieces.

Different approaches are carried out to inspect prepared resistance spot welds and assess their quality. The approaches are ordinarily bifurcated into destructive and non-destructive procedures. Perhaps most common for connectors in automotive applications is a destructive test in which the attached metal walls are physically peeled apart at the location of the intended spot weld, and the exposed area is visually evaluated and measured as good or bad. But once peeled apart, the tested connector is damaged and deemed unsatisfactory for subsequent installation and use. Moreover, only intermittent samples of produced connectors can be subject to testing due to its destructive nature—for instance, perhaps a sampling is taken and tested every hour or so amid production.

A common non-destructive test in automotive applications, on the other hand, is ultrasonic testing. But observed drawbacks of this approach include the relatively high cost of implementation, the specialized training and experience demanded of testing personnel, and the sensitivity of the measurements taken. Still, other kinds of non-destructive testing include visual inspection, penetrant testing, eddy current testing, magnetic particle testing, and x-ray testing, among others. As a general matter, these past efforts share one or more of the drawbacks observed with ultrasonic testing.

### SUMMARY

In an embodiment, a connector may include a band, a wall portion, and one or more windows. The band is composed of a metal material. The wall portion is likewise composed of a metal material. The window(s) resides in the band at a resistance spot-welding site, or resides in the wall portion at a resistance spot-welding site. When the band and wall portion are brought together and a resistance spot weld is established at the resistance spot-welding site. A resistance spot weld formation is capable of being viewed by way of the window(s).

In an embodiment, a method of attaching a first metal wall portion of a connector to a second metal wall portion of the connector to each other may involve various steps. One step may include producing one or more windows in the first metal wall portion. The window(s) spans wholly through the first metal wall portion. Another step may include bringing the first metal wall portion and the second metal wall portion together in abutment. The window(s) is situated at a site of the abutment. Yet another step may include establishing a resistance spot weld formation at the site of abutment between the first metal wall portion and the second metal wall portion. The resistance spot weld formation is located near the window(s).

In an embodiment, a connector may include a first metal wall portion, a second metal wall portion, one or more windows, and one or more spot weld formations. The first metal wall portion has a resistance spot-welding site. The window(s) resides in the first metal wall portion. The window(s) is located at the resistance spot-welding site. The window(s) spans wholly through the first metal wall portion at the resistance spot-welding site. The resistance spot weld formation(s) is located between the first metal wall portion and the second metal wall portion. The resistance spot weld formation(s) is exposed to view at the first metal wall portion by way of the window(s).

### BRIEF DESCRIPTION OF THE DRAWINGS

Embodiments of the disclosure are described with reference to the appended drawings, in which:

FIG. 1 is a perspective view of an embodiment of a connector;

FIG. 2 is a sectional view of the connector, as well as a depiction of spot welding electrodes;

FIG. 3 is a top view of a band of the connector, showing an embodiment of a window residing in the band;

FIG. 4A shows the window before resistance spot welding;

FIG. 4B shows the window after resistance spot welding, this resistance spot weld deemed a proper weld;

FIG. 5 shows the window after resistance spot welding, this resistance spot weld deemed an improper weld;

FIG. 6A is an image of an embodiment of the window, showing a proper weld;

FIG. 6B is an image of an embodiment of the window, showing an improper weld;

FIG. 7A is an image of an embodiment of the window, showing an improper weld; and

FIG. 7B is an image of an embodiment of the window, showing a proper weld.

### DETAILED DESCRIPTION

With reference to the figures, an embodiment of a connector 10 is presented that has one or more windows 12 residing in one of its wall portions. By way of the window(s) 12, an inspector can visually view and examine whether an intended resistance spot weld is properly established at the wall portion. A determination of a good spot weld or a bad spot weld can be made via the window(s) 12. The window(s) 12 provides an effective non-destructive way for weld inspection and verification, in lieu of destructive testing procedures that damage products and can only be performed on a periodic basis, and in lieu of non-destructive testing procedures that demand specialized equipment and specialized personnel. Of course, the window(s) 12 can be employed to supplement other destructive and non-destructive testing procedures, and vice versa. This description presents the connector 10 in the context of an automotive application, but the connector 10 has broader application and is suitable for use in aerospace, marine, machine, and agricultural applications, as well as others. Furthermore, unless otherwise specified, the terms radially, axially, and circumferentially, and their grammatical variations refer to directions with respect to the generally circular shape of the connector 10 as illustrated in the figures. In this sense, axially refers to a direction that is generally along or parallel to a central axis of the circular shape, radially refers to a direction that is generally along or parallel to a radius of the circular shape, and circumferentially refers to a direction that is generally along or in a similar direction as a circumference of the circular shape.

As used herein, the term “connectors” is used expansively to refer to connectors, clamps, couplers, and fasteners of various sorts that are used to join metal pipes, rubber hoses, and other tubular bodies and lines together and thereby establish a fluid-tight joint therebetween. A pipe clamp, for example, secures pipe ends together such as automotive exhaust pipes. The pipe ends can be configured as telescopically overlapping ends or end-to-end abutting ends. A hose clamp, on the other hand, secures water lines, fuel lines, and oil lines, to name a few examples.

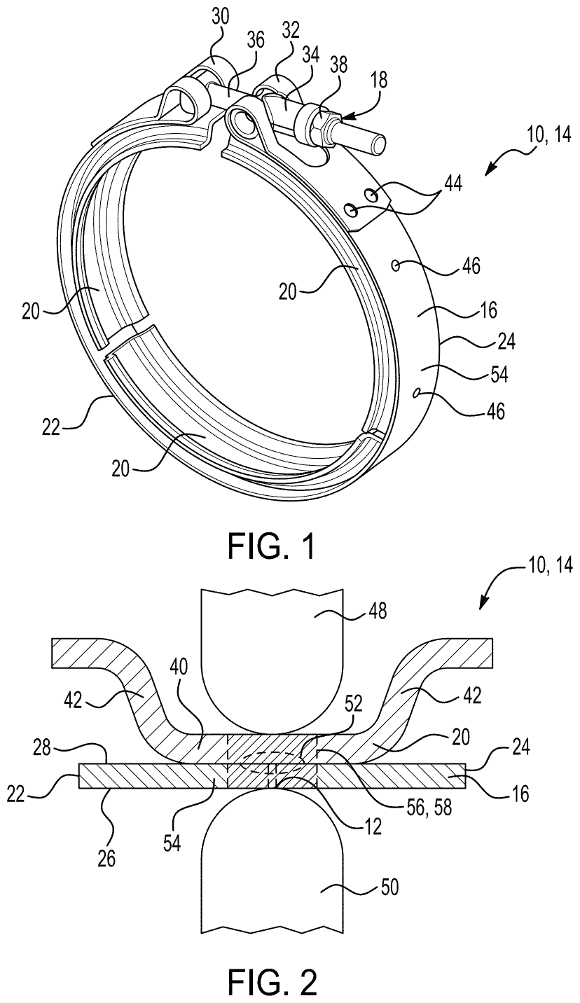

With particular reference now to FIG. 1, the connector 10 is presented as an example v-clamp 14. The v-clamp 14, in general, has a band 16, a latch assembly 18, and a number of v-insert segments 20. The band 16 can be made by stamping sheet metal and then bending the stamped piece into a roundish shape. The band 16 can be composed of a stainless-steel material, or some other metal material. The band 16 has a first and second axial end 22, 24, an outer surface 26, and an inner surface 28. In an example, the band 16 has a thickness dimension measured between the outer and inner surfaces 26, 28 of approximately 1.5 millimeters (mm); still, in other examples the thickness dimension can have other values, depending on the application. For installation of the latch assembly 18, on each circumferential end the band 16 has a first and second loop 30, 32. The first and second loops 30, 32 are established when end sections of the band 16 are folded back onto themselves. Openings in the band 16 and at the first and second loops 30, 32 receive parts of the latch assembly 18.

The latch assembly 18 brings the circumferential ends of the band 16 toward and away from each other in order to tighten and loosen the v-clamp 14. In this example, the latch assembly 18 is a T-bolt type latch assembly and includes a trunnion 34, a fastener 36, and a nut 38. Still, when the connector 10 is a pipe clamp according to another example, a nut and bolt tightening mechanism can be provided for this purpose; and in yet another example when the connector 10 is a hose clamp, a worm drive mechanism can be provided for this purpose.

The v-insert segments 20 are located radially underneath and inboard of the band 16 and, in use and installation, receive end flanges of tubular bodies subject to joining. In this example there are a total of three v-insert segments 20. The v-insert segments 20 are positioned around the circumference of the band 16 and spaced apart from one another with small gaps at confronting free ends between neighboring v-insert segments. The v-insert segments 20 can be composed of a stainless-steel material, or some other metal material. Each v-insert segment 20 has a base wall 40 and a pair of side walls 42 depending therefrom.

Resistance spot welds are prepared at various locations of the connector 10 in order to form attachments between abutting metal walls. In the example v-clamp 14, for instance, a first set of resistance spot welds 44 is formed at the first and second loops 30, 32 and between abutting wall portions of the band 16. Two resistance spot welds 44 are furnished at each loop 30, 32 in this example. Further, a second set of resistance spot welds 46 is formed between abutting wall portions of the band 16 and the v-insert segments 20. Two resistance spot welds 46 are furnished at each v-insert segment 20 in this example, in order to attach each v-insert segment 20 to the band 16. Still, in other examples resistance spot welds form attachments between abutting metal walls of other components, there can be more than two abutting metal walls such as three, and there can be different quantities of resistance spot welds. For instance, when the connector 10 is a hose clamp, resistance spot welds form attachments between abutting wall portions of its band and its worm drive mechanism.

Referring to FIG. 2, a resistance spot welding process is depicted that involves the band 16 and one of the v-insert segments 20. One of the resistance spot welds 46 would then be formed. In general, a first welding electrode 48 and a second welding electrode 50 are brought toward each other and pressed against opposing sides of the band 16 and the v-insert segment 20. The first and second welding electrodes 48, 50 sandwich the band 16 and the v-insert segment 20 together. Electrical current is momentarily passed across the first and second welding electrodes 48, 50 and through the band 16 and v-insert segment 20. Metal material at an interfacial region between the band 16 and v-insert segment 20 melts and a weld nugget 52, or resistance spot weld formation, is formed therebetween upon solidification. The weld nugget 52 can be a mixture of materials of the band 16 and of the v-insert segment 20. The weld nugget 52 joins the band 16 and v-insert segment 20 to each other. In an example, the weld nugget 52 has a diameter dimension of approximately 5 mm; still, in other examples the diameter dimension can have other values, depending on the application. A proper, good weld is typically prepared by the resistance spot welding process depicted and described. But in some cases a faulty, bad weld results. Bad welds, also referred to as cold welds in the resistance spot welding context, can occur due to different causes including insufficient surface-to-surface contact between the wall portions at the interfacial region. A bad weld may be constituted by the lack of formation of a weld nugget, or by an insufficiently-formed weld nugget. In the past, a common approach to inspect resistance spot welds and determine if a bad weld resulted was through a destructive testing procedure in which the wall portions subject to the resistance spot welding process were physically peeled apart, damaging the connector. And this could only be done intermittently due to its destructive nature. An enduring deficiency and demand has hence persisted for an uncomplicated, yet effective non-destructive weld inspection and verification measure.

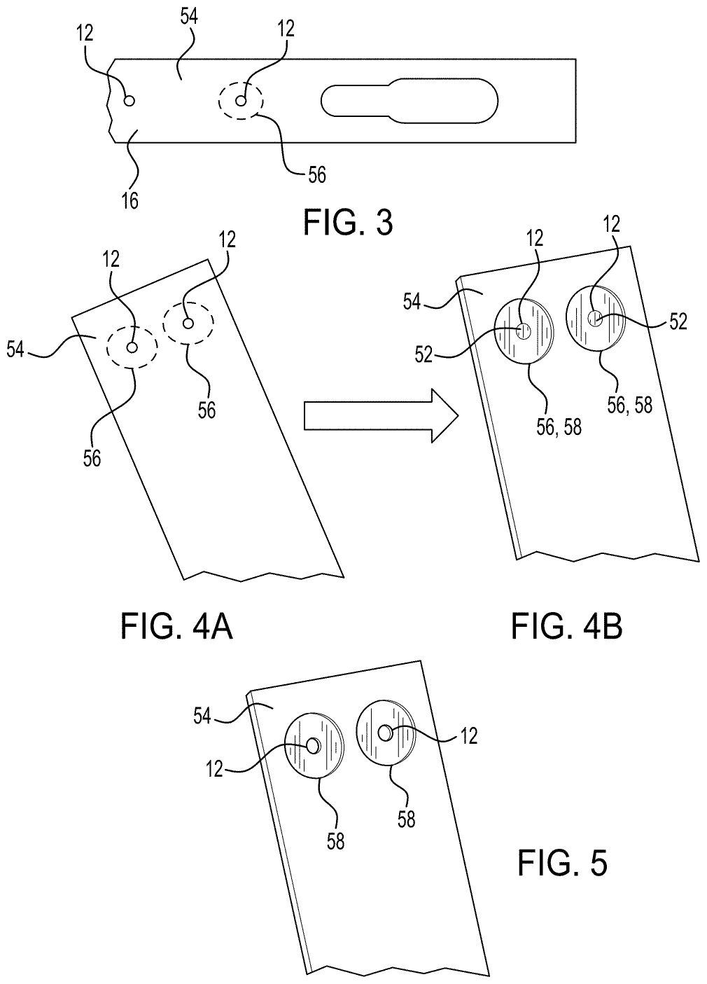

The window(s) 12 resolves the shortcomings of past approaches and provides an effective non-destructive way for weld inspection and verification that can be recurring on all resistance spot welds in the connector 10, for example. Through the window(s) 12, an inspector can visually view and examine whether the intended weld nugget 52 has been formed and thus whether a good weld or a bad weld resulted. In the embodiment of the figures, and referring now to FIGS. 2-4, the window(s) 12 is a through-hole that can reside in at least one of the abutting wall portions subject to resistance spot welding. The window(s) 12 can be a pin hole that is circular in shape, and can have a diameter ranging between approximately 4.83 mm and 5.33 mm; still, in other examples the diameter dimension can have other values. The window(s) 12 can be produced via a stamping, punching, machining or any other manufacturing process. The window(s) 12 spans wholly through the wall portion from one exterior surface to the other, with open ends at each surface. In the example v-clamp 14, the windows 12 are located in the band 16 and span between the outer and inner surfaces 26, 28; in other embodiments, the window(s) 12 could be located in the v-insert segments 20. The wall in which the window(s) 12 resides can constitute a wall portion 54. The wall portion 54 could be of the band 16, the v-insert segments 20, the loops 30, 32, or some other component in other embodiments.

When located in the band 16, the window(s) 12 would then be readily visible and viewable by an inspector from an exterior of the v-clamp 14. Furthermore, the window(s) 12 could be located in the first and second loops 30, 32, where the window(s) 12 would again be readily visible and viewable. The window(s) 12 can be incorporated in some or all of the first set of resistance spot welds 44 and in some or all of the second set of resistance spot welds 46. In order to make examination of the weld nugget 52, the window(s) 12 is located at a resistance spot-welding site 56 of the wall portion 54. The resistance spot-welding site 56 can be an area of the wall portion 54 that will undergo and be subject to the resistance spot welding process. The resistance spot-welding site 56 can have a larger extent and diameter than the weld nugget 52. The first and second sets of resistance spot welds 44, 46, for example, are formed at resistance spot-welding sites 56 in the v-clamp 14. A heat-affected zone (HAZ) 58, which is formed via the resistance spot welding process, can approximate the resistance spot-welding site 56 in terms of size and location. As illustrated in FIGS. 2-5, the window(s) 12 has a transverse extent (i.e., diameter in circular implementation) that is smaller than, and has a lesser value than, a similarly-taken transverse extent of the resistance spot-welding site 56 and of the heat-affected zone 58. Likewise, the transverse extent of the window(s) 12 is smaller than, and has a lesser value than, a similarly-taken transverse extent of the weld nugget 52; this particular comparison is perhaps most evident in FIG. 2. The window(s) 12 is located within the confines of the resistance spot-welding site 56 and of the heat-affected zone 58.

Providing the window(s) 12 at the resistance spot-welding site 56 may, in at least certain regards, seem incompatible with and counterintuitive to efforts of establishing a proper resistance spot weld since material that would otherwise be a part of the ultimately-formed resistance spot weld is being taken away in order to establish the void of the window(s) 12. The window(s) 12 removes structure and material in the wall portion 54 that would be involved in the formation of the weld nugget 52. To counteract potential negative implications and compensate for the loss of material, the overall size of the resistance spot-welding site 56—and hence of the heat-affected zone 58—may be increased in certain embodiments compared to its size when the window(s) 12 is not provided. In an example, the resistance spot-welding site 56 is increased by approximately the same area as the area removed by the window 12 in order to facilitate use of the window(s) 12 and help ensure proper formation of the weld nugget 52. In a specific example, the resistance spot-welding site 56 is increased by an area of approximately 19.6 mm² for a window 12 with a pin hole and circular shape having a diameter measuring approximately 5.0 mm. Still, the size increase may have other values in other embodiments, and may not occur in all embodiments.

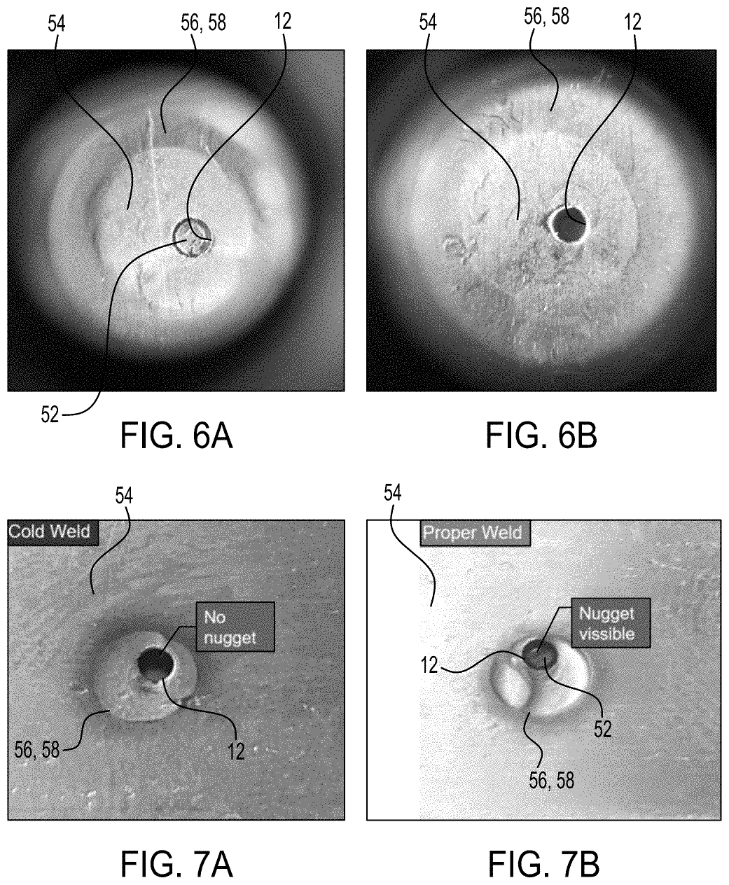

The window(s) 12 furnishes visible access to a portion or more of the weld nugget 52 upon its formation. FIG. 4B depicts a schematic representation of a proper weld nugget formation and a good weld result. In the depiction, the weld nugget 52 is partly viewable via the window(s) 12. Its viewability is an indication of proper formation and a good weld result. Absence thereof, in contrast, is an indication of improper or insufficient formation and a bad weld result. FIGS. 6A and 6B are photographic images of testing conducted and the yielded results. In FIGS. 6A and 6B, a resistance spot welding process was performed like that described with reference to FIG. 2. Melted and solidified material of a portion of the weld nugget 52 is visible by way of the window(s) 12 in FIG. 6A. The melted material can emerge partly through the window(s) 12 where it solidifies and is visible adjacent the open end of the window(s) 12 at the surface of the wall portion 54, as shown in FIG. 6A. FIG. 6A would indicate to an inspector that a proper weld nugget 52 formed and a good weld resulted. FIG. 6B, on the other hand, would indicate to an inspector that a bad weld resulted. Here, melted and solidified material of a weld nugget portion is altogether absent at the window(s) 12. The window(s) 12 remains largely intact and hollow, similar to its condition prior to the resistance spot welding process. Melted material did not emerge through the window(s) 12 and solidify thereat. In some instances, the beneath surface at the interfacial region may be visible via the window(s) 12 upon closer inspection, without the weld nugget 52 present. FIGS. 7A and 7B are also photographic images of testing conducted and the yielded results. Again here, a resistance spot welding process was performed like that described with reference to FIG. 2. In FIG. 7A, melted and solidified material of a weld nugget portion is altogether absent at the window(s) 12 and the window(s) 12 remains hollow and largely intact, indicating a bad weld resulted. By comparison, in FIG. 7B, a portion of the weld nugget 52 is present at the window(s) 12 and is visible thereat, indicating a good weld resulted. It should be appreciated that other testing may yield similar or dissimilar results.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A connector, comprising:
a band composed of metal;
a wall portion composed of metal; and
at least one window residing in said band or residing in said wall portion at a resistance spot-welding site of said band or of said wall portion;
wherein, when said band and said wall portion are brought together and a resistance spot weld is established at said resistance spot-welding site, a resistance spot weld formation is viewable via said at least one window.

2. The connector as set forth in claim 1, wherein the connector is a v-clamp, a pipe clamp, or a hose clamp.

3. The connector as set forth in claim 1, wherein said wall portion is of said band and is brought together with another portion of said band via folding of said band back onto itself.

4. The connector as set forth in claim 1, wherein said wall portion is of a discrete component that is resistance spot welded to said band.

5. The connector as set forth in claim 1, wherein said wall portion is of an insert that is resistance spot welded to said band.

6. The connector as set forth in claim 1, wherein said at least one window spans wholly through said band or spans wholly through said wall portion.

7. The connector as set forth in claim 1, wherein said at least one window has a first transverse extent that is smaller than a second transverse extent of a heat-affected zone of the established resistance spot weld at said resistance spot-welding site.

8. The connector as set forth in claim 1, wherein said at least one window is multiple windows residing in said band or residing in said wall portion at multiple resistance spot-welding sites of said band or of said wall portion.

9. The connector as set forth in claim 1, wherein said at least one window is at least one pin hole.

10. A method of attaching a first metal wall portion of a connector to a second metal wall portion of the connector together, the method comprising:
producing at least one window in said first metal wall portion of the connector, said at least one window spanning wholly through said first metal wall portion;
bringing said first metal wall portion and said second metal wall portion together in abutment, said at least one window situated at a site of the abutment; and
establishing a resistance spot weld formation at the site of the abutment between said first metal wall portion and said second metal wall portion, said resistance spot weld formation located adjacent said at least one window.

11. The method as set forth in claim 10, wherein said at least one window has a first transverse extent that is smaller than a second transverse extent of a heat-affected zone of the established resistance spot weld formation.

12. The method as set forth in claim 10, further comprising increasing a first area of a resistance spot-welding site of the established resistance spot weld formation by approximately a second area of said at least one window.

13. A connector, comprising:
a first metal wall portion having a resistance spot-welding site;
a second metal wall portion;
at least one window residing in said first metal wall portion and located at said resistance spot-welding site, said at least one window spanning wholly through said first metal wall portion at said resistance spot-welding site; and
at least one resistance spot weld formation located between said first metal wall portion and said second metal wall portion, said at least one resistance spot weld formation exposed to view at said first metal wall portion via said at least one window.

14. The connector as set forth in claim 13, wherein the connector is a v-clamp, a pipe clamp, or a hose clamp.

15. The connector as set forth in claim 13, wherein said at least one window has a first transverse extent that is smaller than a second transverse extent of a heat-affected zone of the at least one resistance spot weld formation.

16. The connector as set forth in claim 13, wherein said at least one window is multiple windows residing in said first metal wall portion at multiple resistance spot-welding sites of said first metal wall portion.

17. The connector as set forth in claim 13, wherein said at least one window is at least one pin hole.
